(19) United States
(12) Patent Application Publication
(10) Pub. No.: US 2013/0128561 A1
(43) Pub. Date: May 23, 2013

(54) MULTI-ADJUSTABLE LED LUMINAIRE WITH INTEGRATED ACTIVE COOLING SYSTEM

(71) Applicant: ELECTRALED, INC., Largo, FL (US)

(72) Inventors: James THOMAS, Tierra Verde, FL (US); Vladimir VOLOCHINE, Safety Harbor, FL (US)

(73) Assignee: ELECTRALED, INC., Largo, FL (US)

(21) Appl. No.: 13/672,303

(22) Filed: Nov. 8, 2012

Related U.S. Application Data
(60) Provisional application No. 61/557,074, filed on Nov. 8, 2011.

(51) Int. Cl. F21V 29/00

(52) U.S. Cl. CPC F21V 29/22
USPC 362/157

(57) ABSTRACT

The present invention provides a multi-adjustable LED luminaire having an integrated active cooling system to minimize heat buildup and increase operating performance. The multi-adjustable LED luminaire can have a generally cylindrical configuration, or a generally spherical configuration, and is operably connected to an elongated track that supplies power to the luminaire. The LED luminaire includes an upper housing segment having a power supply, and a lower housing segment that includes the active cooling system and an LED light engine coupled to a heat sink. The active cooling systems draws ambient air into a rearward portion of the housing and forces air over the heat sink and LED light engine. A power distribution PCB of the cooling system monitors the temperature of the heat sink and can adjust power delivery to the LED based upon the temperature.

### CROSS-REFERENCE TO RELATED APPLICATIONS

This application claims the benefit of and priority to U.S. Provisional Patent Application No. 61/557,074, filed Nov. 8, 2011, the entire contents of which are hereby incorporated by reference.

### TECHNICAL FIELD

This invention relates to a relatively compact, multi-adjustable LED luminaire for use with a lighting track and having an integrated active cooling system.

### BACKGROUND OF THE INVENTION

Light fixtures, including luminaires, using light emitting diode (LED) as the light source are well-known. During operation, LED light fixtures generate considerable heat and the conventional solution for heat dissipation is a passive heat sink. The use of a passive heat sink has limitations, including the dimensions, namely surface area, and weight of the heat sink relative to the fixture and its form factor. These limitations are exacerbated when a more powerful LED light engine is employed in the fixture because it can increase the amount of heat that needs to be transferred by the heat sink. A person of ordinary skill in the art of designing lighting fixtures and systems recognizes that it is not always feasible to enlarge the heat sink to dissipate heat generated by the LED light engine. Furthermore, when clustered LEDs or an array of LEDs are utilized, enlarging the heat sink is counterproductive due the increase in thermal resistance of heat sink materials, including aluminum and copper. The use of a heat piping system, which is typically heavy and expensive, is not a practical solution for many fixture designs and installations.

The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention relates to a multi-adjustable LED luminaire having an integrated, active cooling system to minimize heat buildup and increase operating performance. The inventive multi-adjustable LED luminaire has a relatively compact cylindrical configuration and is operably connected to an elongated track that supplies power to the luminaire. The inventive multi-adjustable LED luminaire includes a housing including an upper housing portion with a power supply that converts AC power provided by the track to low voltage DC power, and a lower housing portion that includes a LED light engine coupled to a heat sink and the active cooling system. In a first embodiment, a unique adjustment mechanism is provided between the upper and lower housing portions to allow for rotation of the lower housing portion relative to the upper housing portion. Each of the upper and lower housing portions has a central axis and when the central axes of these portions are aligned to form one continuous axis, the inventive luminaire of the first embodiment has an elongated tubular configuration, preferably elliptical or circular in cross-section. In a second embodiment, a substantially spherical lower housing portion is pivotally coupled to the lower end of an elongated upper housing portion. The upper housing portion of the second embodiment may have an elongated tubular configuration, preferably elliptical or circular in cross section. In both the first embodiment and the second embodiment, the integrated active cooling systems draws ambient air into the housing, namely the lower housing portion, and across the heat sink and LED light engine prior to discharge through an opening in the lower portion.

Accordingly, in some aspects, a multi-adjustable LED lighting fixture includes an upper housing including a power supply, a lower housing, and an adjustment mechanism rotatably coupling the lower housing to the upper housing. A heat sink is mounted within the lower housing and includes a first side and a second side. An internal cooling system is mounted within the lower housing on the first side of the heat sink, and an LED light engine is mounted within the lower housing on the second side of the heat sink.

In other aspects, a multi-adjustable LED lighting fixture includes a first housing including a power supply, and a second housing rotatably coupled to the first housing. The second housing includes a forward end defining a forward opening and a rearward end defining a rearward opening. A heat sink is mounted within the second housing and includes a first side facing the rearward end of the second housing and a second side facing the forward end of the second housing. The heat sink includes a plurality of fins. An LED light engine is coupled to the first side of the heat sink and is configured to project light forwardly from the forward end of the second housing. A fan is mounted within the second housing on the first side of the heat sink. The second housing, the fan, and the heat sink cooperate to define an air flow path for the flow of ambient air into the second housing through the rearward opening, through the fan, through the fins in the heat sink, over the light engine, and out of the second housing through the forward opening.

In still other aspects, a method for cooling an LED lighting fixture includes installing a power supply in a first housing, rotatably coupling a second housing to the first housing, and positioning a heat sink in the second housing generally to subdivide the second housing into a forward portion and a rearward portion. The heat sink allows fluid communication between the forward portion and the rearward portion. An LED light engine is installed in the forward portion of the second housing, and a fan is installed in the rearward portion of the second housing. Operating the fan draws ambient air into the rearward portion of the second housing and forces the air through the heat sink and into the forward portion of the housing.

### BRIEF DESCRIPTION OF THE DRAWINGS

To understand the present invention, it will now be described by way of example, with reference to the accompanying drawings in which:

FIG. 1 is a perspective view of a LED luminaire;

FIG. 2 is a perspective view of an upper portion of the LED luminaire of FIG. 1;

FIG. 3 is an exploded view of the upper portion of the LED luminaire of FIG. 1;

FIG. 4 is a perspective view of a lower portion of the LED luminaire of FIG. 1;

FIG. 5 shows an exploded view of the lower portion of the LED luminaire of FIG. 1;

FIG. 6 is a cross-sectional view of the lower portion of the LED luminaire of FIG. 1, showing the operation of the integrated active cooling system including the flow of ambient air into and through the lower portion of the luminaire;

FIG. 7 is a front perspective view of a LED luminaire according to another embodiment;

FIG. 8 is a rear perspective view of the LED luminaire of FIG. 7; and,

FIG. 9 is a side view of the LED luminaire of FIG. 7 with a lower portion housing removed to reveal operation of the integrated active cooling system.

### DETAILED DESCRIPTION

While this invention is susceptible to embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

A multi-adjustable LED luminaire 10 having an integrated active cooling system is shown in the Figures. The LED luminaire 10 comprises an elongated, tubular housing 20 that is preferably elliptical in cross-section and that includes an upper housing portion 200, a lower housing portion 300, and an adjustment mechanism 500 that provides for rotation of the lower portion 300 relative to the upper portion 200. In another embodiment, the housing 20 has a substantially circular cross-section. As explained in greater detail below, the lower portion 300 includes a light engine 305 and an integrated active cooling system 310 that increases the operating performance and life of the luminaire 10.

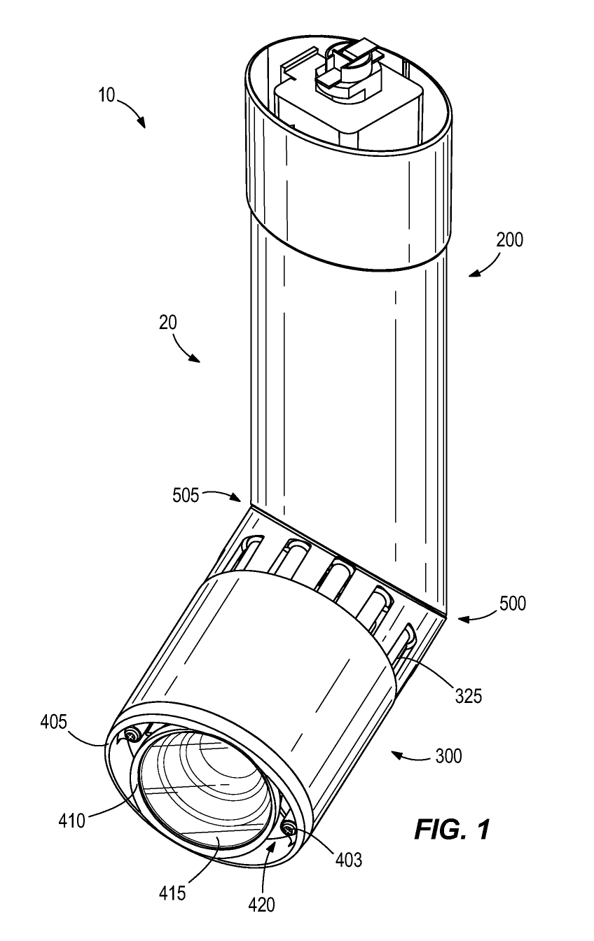

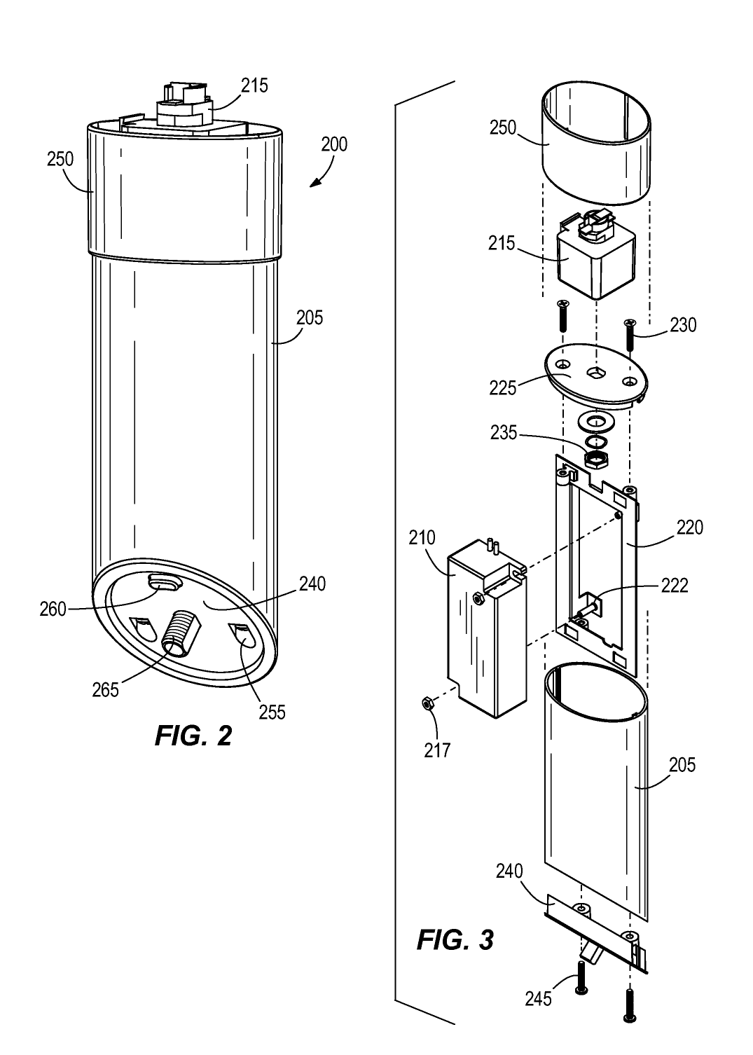

Referring to FIGS. 1-3, the upper housing portion 200 of the luminaire 10 includes an aluminum housing 205, an internal power supply 210 which can include a dimming function, and an adaptor 215 that mechanically and electrically connects the luminaire 10 to an elongated track (not shown). In typical installations, the track is affixed to a support structure, such as a ceiling or wall. The power supply 210 is connected to a support plate 220 by a fastener 217 that receives a pin 222 extending from the plate 220, wherein both power supply 210 and the plate 220 reside within the housing 205. The adaptor 215 is secured to an upper end wall 225 that is joined to the support plate 220 and the housing 205 by at least one fastener 230 and securement means 235. The adaptor 215 allows for approximately 300 degrees of rotation of the luminaire 10 relative to a vertical axis extending through the housing 200. A lower end wall 240 is coupled to the lower end of the housing 205 by at least one fastener 245. The combination of the end walls 225, 240 and the housing 205 form a NEMA electrical enclosure for the power supply 210. The power supply 210 converts alternating current (AC) supplied by the track and that is characterized by high frequency, high voltage with high peak voltages and constant current to a low voltage direct current (DC) signal for operation of the light engine 305 in the lower housing portion 300. Dimming controls and circuitry can be operatively connected to the power supply 210 allow for dimming of the light output. The upper portion 200 includes internal leads (not shown) that electrically interconnect the adaptor 215 and the power supply 210. A sleeve 250 slidingly engages with the housing 205 to cover the adaptor 215 for aesthetic purposes. The lower end wall 240 is sloped or angled and has at least one projection 260 and a central nipple 265 residing radially inward of the projection 260. The end wall 240 also includes an one indent 255 that receives the head of the fastener 245 such that it does not extend above the surface of the end wall 240 and thereby impede rotation of the lower portion 300 relative to the upper portion 200. In one embodiment, the projection 260 and the indent 255 are positioned radially outward from the nipple 265.

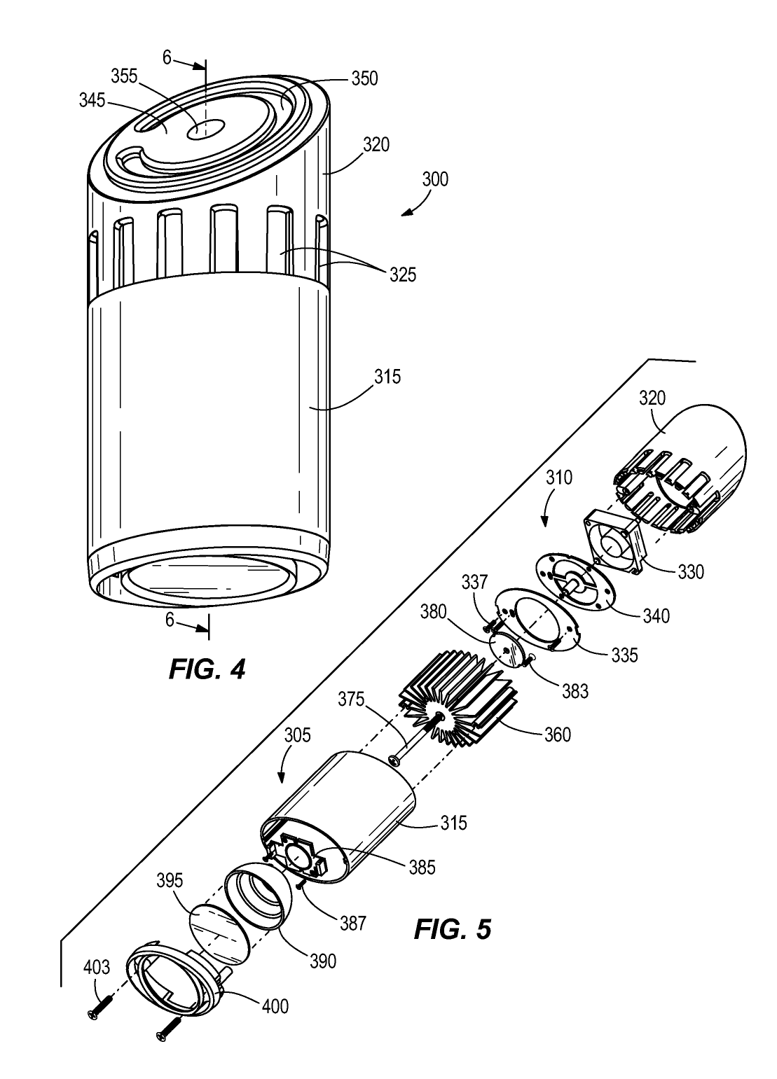

Referring to FIGS. 1, 4 and 5 and as mentioned above, the lower housing portion 300 of the luminaire 10 includes the light engine 305 and the integrated active cooling system 310. The lower housing portion 300 also comprises a first lower housing segment 315 and a second lower housing segment 320. The second lower housing segment 320 has a plurality of openings 325 that allow for the entry of ambient air during operation of the active cooling system 310. Preferably, the openings 325 are arranged along the periphery of the second lower housing 320, and are cooperatively positioned with a fan 330 of the cooling system 310. The first and second lower housing segments 315, 320 are divided by a separator element 335, to which a fan mount plate 340 and the fan 330 are secured thereby forming a fan compartment. These components are secured to an inner receptacle of the second lower housing 320 by at least one fastener 337 that extends through the separator 335, the mount plate 340 and the fan 330. The separator element 335 effectively divides the lower housing portion 300 into two compartments, a fan compartment and a LED compartment. The second lower housing 320 includes an angled or sloped upper end wall 345 with a curvilinear groove 350 and a central receptacle 355 residing radially inward of the groove 350. Preferably, the groove 350 has nearly a circular configuration (see FIG. 4).

The active cooling system 310 also includes a heat sink 360 with a central portion 365 and a plurality of outwardly extending fins 370, preferably constructed from aluminum. An elongated fastener 375 extends through a bore in the central portion 365 and secures the fan 330 and the mount plate 340 to the heat sink 360. A power distribution printed circuit board (PCB) 380 is also secured to an upper portion, preferably an upper, first end surface, of the heat sink 360 adjacent the fan 330 and the fan mount plate 340 by at least one fastener 383. In an assembled position, the power distribution PCB 380 is aligned with a central opening in the separator plate 335 and the fan mount plate 340.

The power distribution PCB 380 includes means for measuring a reference temperature within the lower housing portion 300. In one embodiment, the reference temperature is a temperature of the heat sink 360. For example, the PCB 380 can include voltage regulator circuitry and a thermostat, the former functioning to regulate the drive voltage for the fan 330 and the latter function to measure the temperature of the heat sink 360. In some embodiments, the means for measuring the reference temperature may indirectly measure the temperature of the heat sink 360 or other components, such as the light engine 305, by directly measuring the temperature of another component, including, for example, the temperature of the ambient air within the lower housing portion 300.

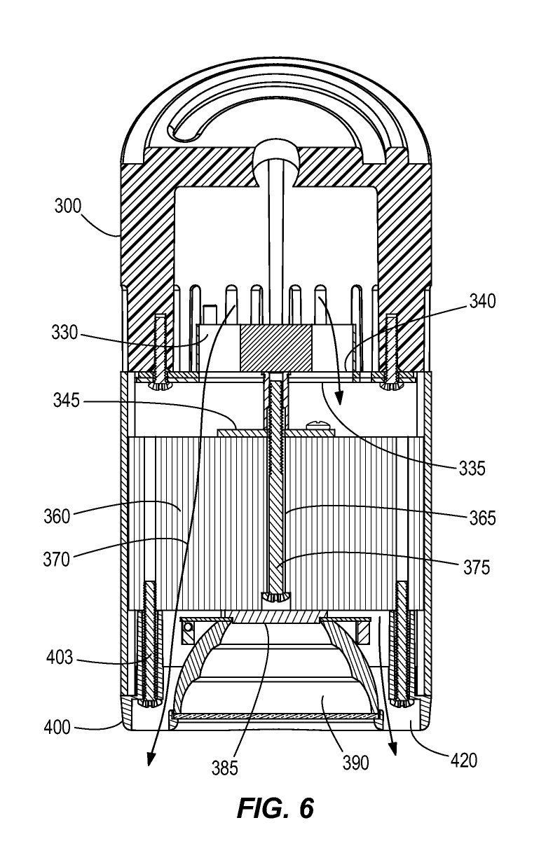

In the assembled position (see FIG. 6), the heat sink 360 resides within the first lower housing segment 315, along with the light engine 305. The light engine 305 includes a light emitting diode (LED) 385 or an array of LEDs 385, wherein fasteners 387 secure the LED 385 to a lower portion, preferably lower, second end surface, of the heat sink 360 (see FIG. 6). Heat generated by the LED 385 during its operation is transferred to the heat sink 360 for dissipation. The light engine 305 also includes a reflector 390, a protective lens 395, a frontal shroud 400 and at least one fastener 403 that connects these components as an assembly. Preferably, the fastener 403 extends through the shroud 395 and the reflector 390 and is received by a front portion of the heat sink 360, namely the fins 370. Referring to FIG. 1, the shroud 400 includes a peripheral ring 405, an inner ring 410 aligned with the frontal portion of the reflector 390, a central aperture 415 within the inner ring 410, and a void or gap 420 defined between the peripheral ring 405 and the inner ring 410.

The adjustment mechanism 500 comprises the lower end wall 240, the projection 260, the central nipple 265, the upper end wall 345, the curvilinear groove 350 and the central receptacle 355. These components operatively interact to provide a joint 505 (see FIG. 1) that enables the lower housing portion 300 to rotate relative to the upper housing portion 200. Specifically, when the luminaire 10 is assembled, the central nipple 265 is rotatably received by the central receptacle 355 and the projection 260 is slidably received by the groove 350. Over-rotation of the lower housing portion 300 relative to the upper housing 200 is prevented when the projection 260 reaches an end of the groove 350. In a preferred embodiment, the lower end wall 240 is angled approximately 45 degrees relative to a longitudinal axis of the upper housing portion 200. The nipple 265 is substantially perpendicular to the lower end wall 240 and is thus angled approximately 45 degrees relative to the longitudinal axis of the upper housing portion 200. Similarly, the upper end wall 345 is angled approximately 45 degrees relative to a longitudinal axis of the lower housing portion 300. The lower end wall 240 and the upper end wall 345 are substantially flush to facilitate sliding engagement there between during rotational movement.

Due to the configuration of its components, the adjustment mechanism 500 provides for roughly 300 degrees of rotation between the upper housing portion 200 and the lower housing portion 300. Moreover, when the lower housing portion 300 is rotated with respect to the upper housing portion 200, an angle between the longitudinal axes of each of the upper and lower housing portions 200, 300 changes. For example, when fully rotated in a first direction, the longitudinal axes of the upper and lower housing portions 200, 300 are substantially axially aligned, such that the luminaire 10 has a substantially straight and elongated configuration. On the other hand, when the lower housing portion 300 is fully rotated in the opposite direction, the longitudinal axes of the upper and lower housing portions 200, 300 are angled with respect to one another but are maintained in an intersecting configuration, substantially as shown in FIG. 1. Rotation of the lower housing portion 300 between the two fully rotated positions adjusts the angle between the longitudinal axes of the upper and lower housing portions 200, 300 to intermediate angles while maintaining the intersecting configuration of the two longitudinal axes. The configuration of the adjustment mechanism, including the angled lower and upper end walls 240, 345, allows for a substantially unlimited number of angled configurations between the substantially straight configuration and the fully angled configuration shown in FIG. 1.

A first set of internal leads (not shown) extends from the power supply 210 through the central nipple 265 and receptacle 355 and into the lower housing portion 300 for connection to the power distribution PCB 380. A second set of internal leads supplies DC power from the power distribution PCB 380 to the LED 385. A third set of internal lead supplies DC power from the power distribution PCB 380 to the fan 330. Thus, the input power provided by the power supply 210 is split by the power distribution PCB 380 to drive both the fan 330 and the LED 385. During operation of the luminaire 10 and as shown in FIG. 6, ambient air (represented by the arrows) is drawn into the lower housing portion 300 through the openings 325 by the fan 330. The fan 330 directs the air flow through the central apertures of the fan mount plate 340 and separator 335 and across the fins 370 of the heat sink 360. Air flows past the fins 370 and through the gap 420 for discharge from the lower housing 300. The operating parameters of the fan 330, including operating speed and supply voltage, are optimized to ensure that the resulting air flow overcomes the static pressure in the lower housing portion 300 near the light engine 305 and the reflector 390 to ensure sufficient discharge through the gap 420. Accordingly, the integrated active cooling system 310 provides an internal air flow across the heat sink 360 for heat transfer and to maintain a safe operating temperature for the LED 385, which ensures longer life and higher performance.

As mentioned above, the input power provided by the power supply 210 is split by the power distribution PCB 380 to drive both the fan 330 and the LED 385. Preferably, a greater amount of power is provided to the LED 385 than the fan 330. During operation, the power distribution PCB 380 monitors the reference temperature (which is a function of the heat generated by the LED 385 and heat dissipated from the sink 360 by the fan 330). In one embodiment, the thermostat monitors the temperature of the upper end surface of the heat sink 360, which is empirically correlated to the temperature of the heat sink 360 proximate to the LED 385 and/or the temperature of the LED 385. If the measured reference temperature remains at or below a preset level, then the power distribution PCB 380 supplies power to both the LED 385 and the fan 330, via the second and third set of leads, respectively, for operation of these components. If the reference temperature exceeds the preset level, then an “overheat mode” of the power distribution PCB is activated wherein the power distribution PCB 380 continues to supply power to the fan 330 while reducing power to the LED 385, including, in some embodiments, reducing power to the LED 385 to zero and thereby turning the LED 385 off. In the configuration where the power distribution PCB 380 reduces power to the LED 385 to a non-zero value, then the light output of the LED 385 is reduced which results in less heat being generated for dissipation from the heat sink 360 by the fan 330. In the configuration where the power distribution PCB 380 reduces power to the LED 385 to zero, then the light output of the LED 385 is eliminated and no additional heat is being generated. In either configuration of the overheat mode, ambient air is still being drawn into the luminaire 10 by the active cooling system 310 to facilitate heat transfer from the heat sink 360 while overheating of the LED 385 is prevented. Preventing overheating of the LED 385 increases its operating performance, including maintaining a desirable LED junction temperature. In the overheat mode, the power distribution PCB 380 continues to monitor the reference temperature and once it drops below the preset level, the power distribution PCB 380 increases power to the LED 385 for operation of the LED 385 at its standard brightness level. In one embodiment, the power distribution PCB 380 supplies 5 volts to the fan 330 for its operation, and the fan 330 removes 15-20 Watts of heat from the heat sink 360. The fan 330 is sized to overcome static pressure near the light engine 305 and the upper edge of the heat sink 360, and to minimize, and preferably eliminate, gradients along the heat sink 360 when the lower housing portion 300 is in a substantially horizontal position (i.e., oriented 90 degrees from a vertically positioned upper housing portion 200).

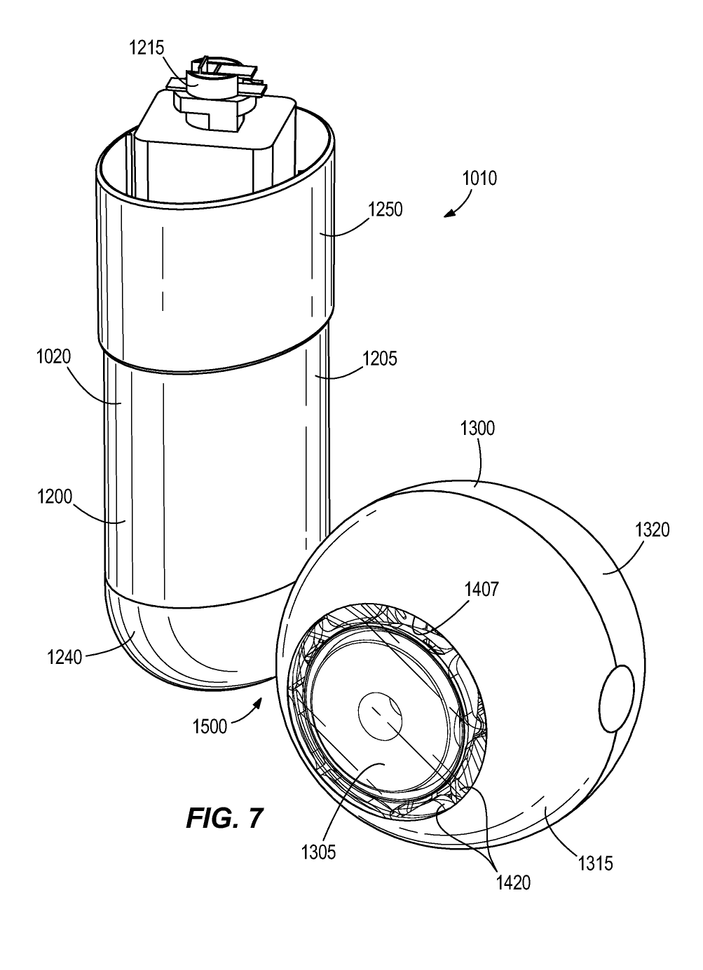

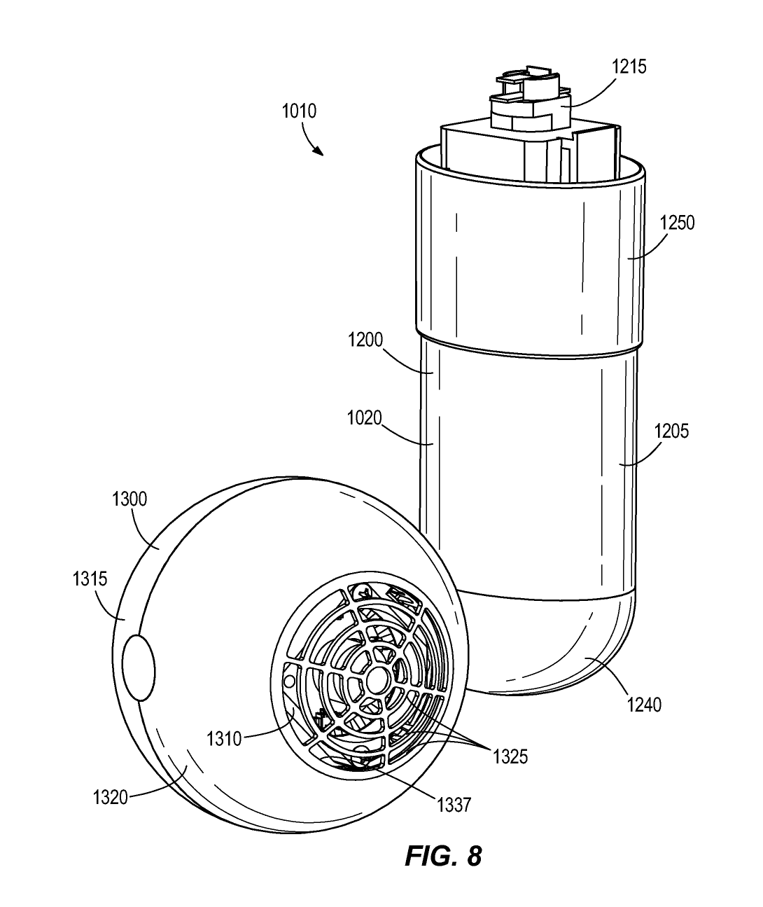

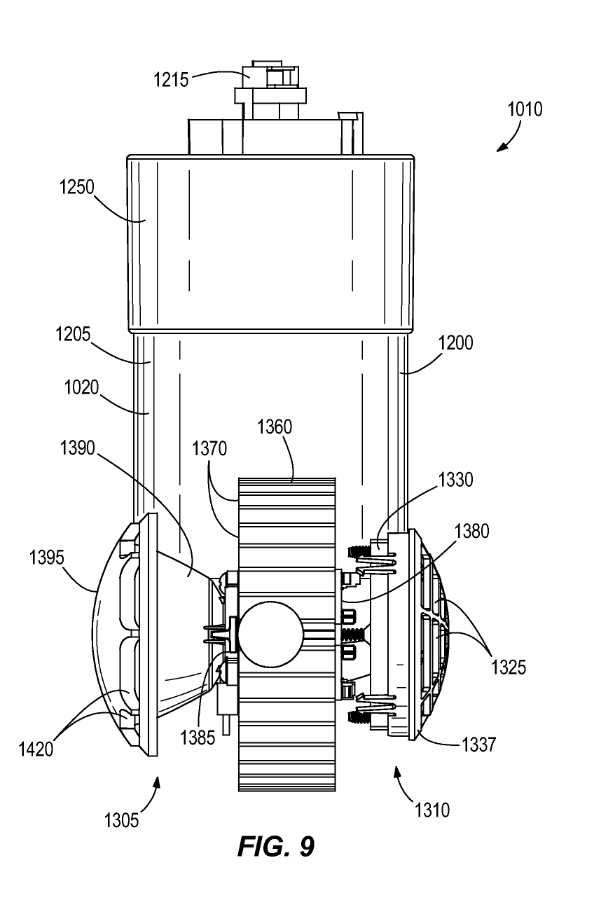

FIGS. 7-9 illustrate an alternative embodiment of an LED luminaire in which components and features corresponding to those of the LED luminaire 10 illustrated in FIGS. 1-8 have been given like reference numerals increased by one-thousand. Referring initially to FIGS. 7 and 9, LED luminaire 1010 comprises an elongated, tubular housing 1020 that includes an upper housing portion 1200, a lower housing portion 1300, and an adjustment mechanism 1500 that provides for rotation of the lower portion 1300 relative to the upper portion 1200. In the illustrated embodiment, the upper housing portion 1200 has a substantially elliptical cross-section, although in other embodiments, the upper housing portion 1200 can have a different cross-section, such as a substantially circular cross-section. In the illustrated embodiment, the lower housing portion 1300 is substantially spherical, although in other embodiments, the lower housing portion 1300 can have other shapes, such as substantially cylindrical, substantially cuboid, and the like. As explained in greater detail below, the lower portion 1300 includes a light engine 1305 (FIG. 7) and an integrated active cooling system 1310 (FIG. 8) that increases the operating performance and life of the luminaire 1010. With the exception of the specific shapes of the upper and lower housing portions 1200, 1300 and the specific configuration of the adjustment mechanism 1500, the internal components of the upper and lower housing portions 1200, 1300 are generally similar to those discussed above with respect to the upper and lower housing portions 200, 300.

The upper housing portion 1200 of the luminaire 1010 includes an aluminum housing 1205, an internal power supply (not shown) which can include a dimming function, and an adaptor 1215 that mechanically and electrically connects the luminaire 1010 to an elongated track (not shown). In typical installations, the track is affixed to a support structure, such as a ceiling or wall. The power supply can be configured and supported within the upper housing portion 1200 in a manner similar to that discussed above with respect to the powers supply 210. For example, the power supply can convert alternating current (AC) supplied by the track and that is characterized by high frequency, high voltage with high peak voltages and constant current to a low voltage direct current (DC) signal. The power supply can be mounted within the upper housing portion 1200 by a support plate, a fastener, and a pin, such that both the power supply the support plate reside within the housing 1205. The adaptor 1215 allows for approximately 300 degrees of rotation of the luminaire 1010 relative to a vertical axis extending through the housing upper housing portion 1200. Dimming controls and circuitry can be operatively connected to the power supply allow for dimming of the light output. The upper portion 1200 includes internal leads (not shown) that electrically interconnect the adaptor 1215 and the power supply. A sleeve 1250 slidingly engages with the housing 1205 to cover the adaptor 1215 for aesthetic purposes. A lower end cap 1240 covers a lower end of the housing 1205 and is configured to accommodate rotatable mounting of the lower housing portion 1300 to the upper housing portion 1200.

Referring also to FIG. 9, the lower housing portion 1300 of the luminaire 1010 includes the light engine 1305 and the integrated active cooling system 1310. The lower housing portion 1300 also comprises a forward or first lower housing segment 1315 and a rearward or second lower housing segment 1320. The second lower housing segment 1320 has a plurality of openings 1325 that allow for the entry of ambient air during operation of the active cooling system 1310. In the luminaire 1010, the openings 1325 are centrally arranged with respect to the second lower housing segment 1320, and are cooperatively positioned with a fan 1330 of the cooling system 1310. In other embodiments, the openings 1325 may be arranged around the periphery of the second lower housing segment 1320, similar to the openings 325 of the luminaire 10.

The active cooling system 1310 includes a heat sink 1360 with a plurality of outwardly extending fins 1370, preferably constructed from aluminum. Each of the first lower housing segment 1315 and the second lower housing segment 1320 is coupled to the heat sink 1360 by a pair of fasteners (not shown). The fan 1330 is secured by fasteners to the second lower housing segment 1320, and a vent portion 1337 of the second lower housing segment 1320 snaps into position over the fan 1330. In the illustrated embodiment the vent portion 1337 defines the openings 1325. The heat sink 1360, the second lower housing segment 1320, and the vent portion 1337 cooperate to form a fan compartment. The heat sink 1360 generally divides the lower housing portion 1300 into two compartments, a rearward fan compartment and a forward LED compartment.

A power distribution printed circuit board (PCB) 1380 is secured to a rearward, first end surface of the heat sink 1360 adjacent the fan 1330. The second lower housing segment 1320 is configured to provide an air flow gap between the fan 1330 and the power distribution PCB 1380, as shown in FIG. 9. Power distribution PCB 1380 includes means to measure the reference temperature within the lower housing 1300, which may be or include, for example, the temperature of the heat sink 1360. In one embodiment, the PCB 1380 includes a voltage regulator circuitry and a thermostat, the former functioning to regulate the drive voltage for the fan 1330 and the latter function to measure the reference temperature. In an assembled position, the power distribution PCB 380 is substantially axially aligned with the fan 1330. When assembled, the heat sink 360 extends between the first lower housing segment 1315 and the second lower housing segment 1320.

The light engine 1305 is configured similarly to the light engine 305, and includes a light emitting diode (LED) 1385 or an array of LEDs secured a forward, second end surface of the heat sink 1360. Heat generated by the LED 1385 during its operation is transferred to the heat sink 1360 for dissipation. The light engine 1305 also includes a reflector 1390 and a protective lens 1395. Preferably, the lens 1395 is supported within an opening 1407 (FIG. 7) defined by the first lower housing segment 1315. The lens 1395 also defines a plurality of voids or gaps 1420 circumferentially spaced around an outer periphery of the lens 1395.

As in the luminaire 10, the input power provided by the power supply of the luminaire 1010 is split by the power distribution PCB 1380 to drive both the fan 1330 and the LED 1385. The power distribution PCB 1380 may also monitor the reference temperature and can include an “overheat mode” similar to that discussed above, wherein the power distribution PCB 1380 continues to supply power to the fan 1330 while reducing (including reducing to zero) power supplied to the LED 1385 in response to the reference temperature exceeding a preset level. While power supplied to the LED 1385 is reduced, the power distribution PCB 1380 may continue to monitor the reference temperature and, when the reference temperature falls below the preset level, the power distribution PCB 1380 may increase power supplied to the LED 1385 to its standard value. During operation of the fan 1330, the fan 1330 draws ambient air into the lower housing portion 1300 through the openings 1325 in the vent portion 1337. The air flows through the fan 1330 and is then forced over the power distribution PCB and through the gaps between the fins 1370 of the heat sink 1360, thereby drawing heat away from the heat sink 1360. The now heated air then flows past the LED 1385 and over the outer surface of the reflector 1390, drawing additional heat from these components. The now further heated air then exits the lower housing portion 1300 by flowing through the gaps 1420 in the lens 1395.

The above-described structures shown in FIGS. 1-9 provide a method for cooling an LED lighting fixture that includes installing a power supply in a first housing, rotatably coupling a second housing to the first housing, and positioning a heat sink in the second housing generally to subdivide the second housing into a forward portion and a rearward portion. The heat sink allows fluid communication between the forward portion and the rearward portion. An LED light engine can be installed in the forward portion of the second housing, and a fan can be installed in the rearward portion of the second housing. Operating the fan draws ambient air into the rearward portion of the second housing and forces the air through the heat sink and into the forward portion of the housing, thereby cooling the LED lighting fixture.

While the specific embodiments have been illustrated and described, numerous modifications come to mind without significantly departing from the spirit of the invention, and the scope of protection is only limited by the scope of the accompanying claims.

What is claimed is:

1. A multi-adjustable LED lighting fixture comprising:
an upper housing including a power supply;
a lower housing;
an adjustment mechanism rotatably coupling the lower housing to the upper housing;
a heat sink mounted within the lower housing and including a first side and a second side;
an internal cooling system mounted within the lower housing on the first side of the heat sink; and
an LED light engine mounted within the lower housing on the second side of the heat sink.

2. The multi-adjustable LED lighting fixture of claim 1, wherein the internal cooling system includes a fan and a power distribution PCB, and wherein the power distribution PCB splits input power provided by the power supply between the fan and the LED light engine.

3. The multi-adjustable LED lighting fixture of claim 2, wherein ambient air is drawn into a rearward portion of the lower housing by the fan and is directed across the heat sink and discharged through a frontal gap in the lower housing.

4. The multi-adjustable LED lighting fixture of claim 2, wherein the power distribution PCB includes means for monitoring the temperature of the heat sink.

5. The multi-adjustable LED lighting fixture of claim 2, wherein the power distribution PCB includes an overheat mode for reducing power supplied to the LED light engine in response to sensing a reference temperature above a preset level while continuing operation of the fan.

6. The multi-adjustable LED lighting fixture of claim 5, wherein when the power distribution PCB enters the overheat mode, the power distribution PCB reduces power supplied to the LED light engine to zero.

7. The multi-adjustable LED lighting fixture of claim 5, wherein when the power distribution PCB enters the overheat mode, the power distribution PCB monitors the reference temperature and, when the reference temperature drops below the preset level, the power distribution PCB increases power to the LED light engine.

8. The multi-adjustable LED lighting fixture of claim 1, wherein the adjustment mechanism includes angled surfaces, and wherein rotation of the lower housing portion with respect to the upper housing portion changes an angle between a longitudinal axis of the lower housing portion and a longitudinal axis of the upper housing portion while maintaining the longitudinal axes in an intersecting configuration.

9. A multi-adjustable LED lighting fixture comprising:
a first housing including a power supply;
a second housing rotatably coupled to the first housing and including a forward end defining a forward opening and a rearward end defining a rearward opening;
a heat sink mounted within the second housing, the heat sink including a first side facing the rearward end of the second housing and a second side facing the forward end of the second housing, the heat sink including a plurality of fins;
an LED light engine coupled to the first side of the heat sink and configured to project light forwardly from the forward end of the second housing; and,
a fan mounted within the second housing on the first side of the heat sink, wherein the second housing, the fan, and the heat sink cooperate to define an air flow path for the flow of ambient air into the second housing through the rearward opening, through the fan, through the fins in the heat sink, over the light engine, and out of the second housing through the forward opening.

10. The multi-adjustable LED lighting fixture of claim 9, wherein the second housing includes a shroud positioned within the forward opening.

11. The multi-adjustable LED lighting fixture of claim 10, wherein the second housing includes a lens mounted within the opening and defining vents.

12. The multi-adjustable LED lighting fixture of claim 10, wherein the second housing includes a forward segment and a rearward segment, and wherein the rearward segment defines the rearward opening.

13. The multi-adjustable LED lighting fixture of claim 12, wherein the rearward opening is one of a plurality of rearward openings, and wherein the plurality of rearward openings are arranged along a periphery of the rearward segment.

14. The multi-adjustable LED lighting fixture of claim 9, further comprising a power distribution PCB mounted within the second housing, wherein the power distribution PCB splits input power provided by the power supply between the fan and the LED light engine.

15. The multi-adjustable LED lighting fixture of claim 14, wherein the power distribution PCB monitors a reference temperature within the second housing, and wherein when the reference temperature exceeds a preset level, the power distribution PCB reduces power output to the LED light engine while maintaining electrical power to the fan.

16. A method for cooling an LED lighting fixture, the method comprising:
installing a power supply in a first housing;
rotatably coupling a second housing to the first housing;
positioning a heat sink in the second housing generally to subdivide the second housing into a forward portion and a rearward portion, the heat sink allowing fluid communication between the forward portion and the rearward portion;
installing an LED light engine in the forward portion of the second housing;
installing a fan in the rearward portion of the second housing; and
operating the fan to draw ambient air into the rearward portion of the second housing and to force air through the heat sink and into the forward portion of the housing.

17. The method of claim 16, wherein installing the LED light engine includes directly mounting at least a portion of the LED light engine to the heat sink.

18. The method of claim 16, further comprising installing a power control PCB in the second housing, and wherein operating the fan includes the power control PCB splitting input power provided by the power supply between the LED light engine and the fan.

19. The method of claim 18, further comprising reducing the power supply to the LED light engine in response to a threshold temperature exceeding a preset level.
